(19) United States
(12) Patent Application Publication
(10) Pub. No.: US 2018/0322533 A1
(43) Pub. Date: Nov. 8, 2018

(54) INTERACTIVE ADVERTISING DEVICE AND SYSTEM

(71) Applicant: Jeff Dehaven, Austin, TX (US)

(72) Inventor: Jeff Dehaven, Austin, TX (US)

(21) Appl. No.: 15/724,960

(22) Filed: Oct. 4, 2017

Related U.S. Application Data
(60) Provisional application No. 62/502,012, filed on May 5, 2017.

(51) Int. Cl. G06Q 30/02; G09F 19/02; G09F 9/33; G09F 9/35; G09F 19/18

(52) U.S. Cl. CPC G06Q 30/0267; G09F 19/02; G06Q 30/0277; G09F 9/35; G09F 19/18; G09F 9/33

(57) ABSTRACT

An interactive advertising device may include a base and a display. The display may be coupled to the base with one or more movable couplings which may be positioned on opposing ends of the display. One or more mounts may be configured to couple the base to an object or surface. The display may comprise a display area which may be configured to display information, such as indicia and graphics, to observers of the device. An optional traffic light sensor may determine the status of a traffic light near or proximate to the device, and the device may turn on, turn off, and/or alter the information displayed by the display in response to the status of the traffic light. An optional radio module may enable the device to send and receive data in a wireless manner such as from a client device of an observer and/or from a wireless network.

### CROSS REFERENCE TO RELATED APPLICATIONS

This application claims priority to and the benefit of the filing date of U.S. Provisional Application No. 62/502,012, filed on May 5, 2017, entitled “INTERACTIVE ADVERTISING DEVICE”, which is hereby incorporated by reference in its entirety.

### FIELD OF THE INVENTION

This patent specification relates to the field of devices configured to provide information to consumers. More specifically, this patent specification relates to interactive advertising signage devices which are able to provide varying information to consumers.

### BACKGROUND

Advertisers and other organizations frequently need to provide information to consumers and other interested parties for a variety of purposes. Advertisers may seek to provide brand or product information to create or increase sales. Charitable organizations may seek to provide cause information to solicit donations. Transportation organizations may seek to provide traffic pattern and other advisory data to facilitate the movement of vehicles. For this reason, new devices capable of conveying varying information are always needed.

Current information providing devices include billboards, road signs, traffic signs, signs mounted on vehicles, signs mounted on buildings, and the like. However, these current devices suffer from a number of drawbacks. Billboard devices and signs mounted on building structures, while useful for providing information at a distance due to their large size, must be positioned a significant distance from the observer which can make it difficult for the observer to see or to record the information with a client device such as a smart phone. Road signs and traffic signs, while smaller and closer to observers, are semi-permanent devices which are difficult to reconfigure or change. Signage devices mounted on vehicles may be difficult to observe due to movement of the vehicle, obstruction by other vehicles, and movement of the observer.

Therefore a need exists for novel interactive advertising signage devices and systems capable of conveying information to consumers and observers. There is also a need for novel interactive advertising signage devices and systems which are able to provide varying information to consumers and observers. A further need exists, for novel interactive advertising signage devices and systems which are easy to reconfigure and change. Finally, a need exists for novel interactive advertising signage devices and systems which facilitate the ability of an observer to see or to record the information with a client device such as a smart phone.

### BRIEF SUMMARY OF THE INVENTION

An interactive advertising device is provided. In some embodiments, the device may include a base and a display. One or more mounts may be configured to couple the base to an object or surface. The display may be coupled to the base with one or more movable couplings which may be positioned on opposing ends of the display. The display may comprise a display area which may be configured to display varying information, such as advertising information, charity donation information, traffic advisory alert information, missing person information, blood donation information, or any other information. The display area may be configured to display information, such as indicia and graphics, to observers of the device preferably in proximity to a road surface, intersection, or walkway. The display may be moved relative to the base to facilitate the ability of observers to view the display and any information displayed thereon.

In further embodiments, the device may include a base and a display having a digital display area which may be configured to visually display data. A movable coupling may movably couple the display to the base. A traffic light sensor may determine a status of a traffic light proximate to the device. Visually displayed data on the display area may be changed in response to a change in the status of the traffic light.

In further embodiments, the device may comprise an optional radio module which may enable the device to send and receive data in a wireless manner such as with a client device of an observer or user and/or with a wireless network.

According to another aspect, an interactive advertising system is provided. In some embodiments, the system may include a client device and an interactive advertising device. The interactive advertising device may include a base and a display having a digital display area which may be configured to visually display data. A movable coupling may movably couple the display to the base, and a radio module may be configured to communicate with the client device A traffic light sensor may determine a status of a traffic light proximate to the device. Visually displayed data on the display area may be changed in response to a change in the status of the traffic light.

In further embodiments, the system may further include a server, and the radio module may be in communication with the server.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a perspective view of an example of an interactive advertising device according to various embodiments described herein.

FIG. 2 illustrates a front elevation view of another example of an interactive advertising device according to various embodiments described herein.

3 FIG. 3 shows a side elevation view of a further example of an interactive advertising device according to various embodiments described herein.

FIG. 4 depicts a perspective view of another further example of an interactive advertising device according to various embodiments described herein.

FIG. 5 illustrates a perspective view of still another example of an interactive advertising device according to various embodiments described herein.

FIG. 6 shows a block diagram showing an example of an interactive advertising device according to various embodiments described herein.

FIG. 7 depicts a block diagram showing an example of a server which may be used by the system as described in various embodiments herein.

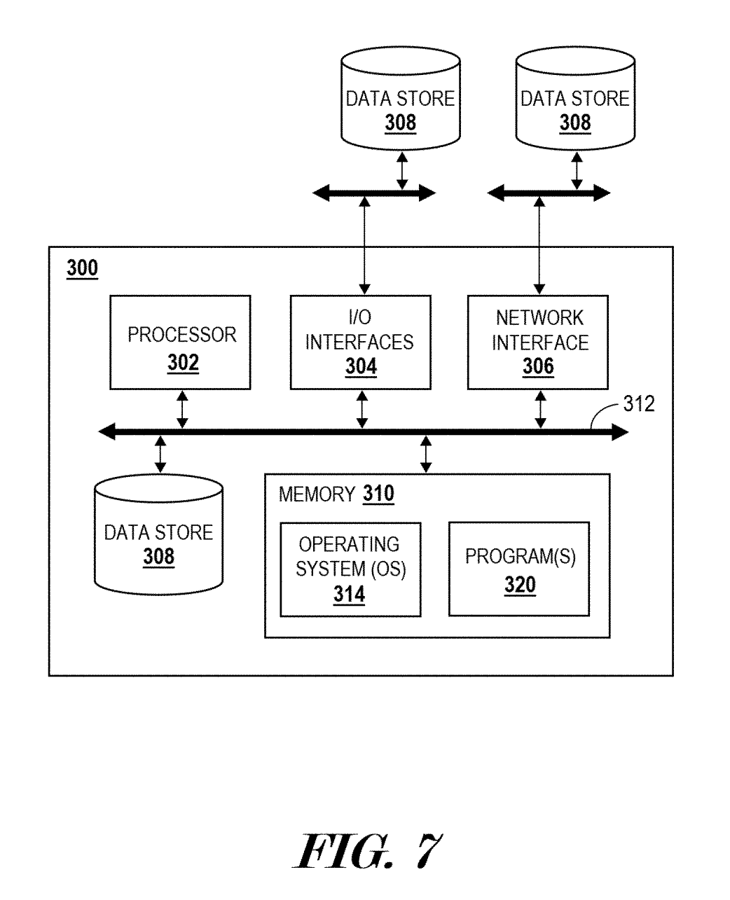

FIG. 8 illustrates a block diagram illustrating an example of a client device which may be used by the system as described in various embodiments herein.

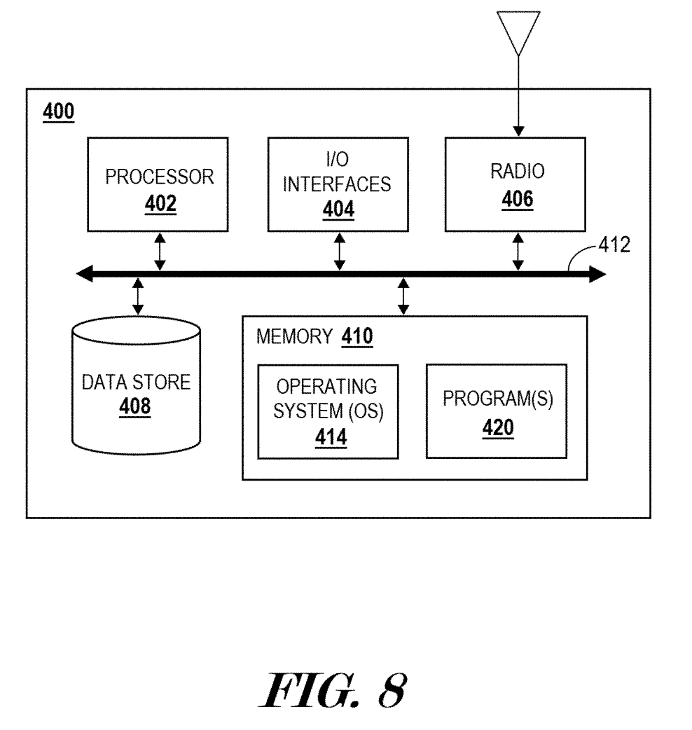

FIG. 9 shows an illustrative example of some of the components of an interactive advertising system according to various embodiments described herein.

FIG. 10 depicts another illustrative example of some of the components of an interactive advertising system according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

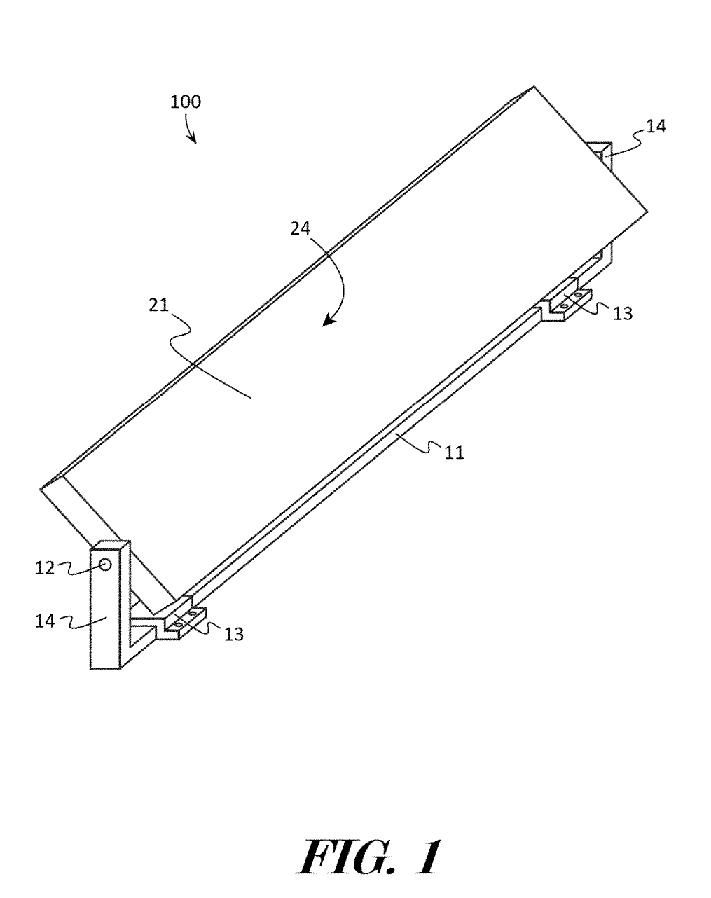

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The term “client device” or sometimes “electronic device” or just “device” as used herein is a type of computer generally operated by a person or user of the system. In some embodiments, a client device is a smart phone or computer configured to receive and transmit data to a server or other electronic device which may be operated locally or in the cloud. Non-limiting examples of client devices include: personal computers (PCs), workstations, laptops, tablet PCs including the iPad, cell phones including iOS phones made by Apple Inc., Android OS phones, Microsoft OS phones, Blackberry phones, or generally any electronic device capable of running computer software and displaying information to a user. Certain types of client devices which are portable and easily carried by a person from one location to another may sometimes be referred to as a “mobile device” or “portable device”. Some non-limiting examples of mobile devices include: cell phones, smartphones, tablet computers, laptop computers, and wearable computers such as Apple Watch, other smartwatches, Fitbit, other wearable fitness trackers, Google Glasses, and the like.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new device configured to provide information to consumers is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

The present invention will now be described by example and through referencing the appended figures representing preferred and alternative embodiments. FIG. 1 illustrates an example of an interactive advertising device (“the device”) 100 according to various embodiments. In some embodiments, the device 100 may comprise a base 11 and a display 21. The display 21 may be coupled to the base 11 with one or more movable couplings 12 which may be positioned on opposing ends of the display 21. One or more mounts 13 may be configured to couple the base 11 to an object or surface. The display 21 may be configured to display information, such as indicia and graphics, to observers or users 201 of the device 100. The display 21 may be moved relative to the base 11 to facilitate the ability of observing users 201 to view the display 21 and any information displayed thereon.

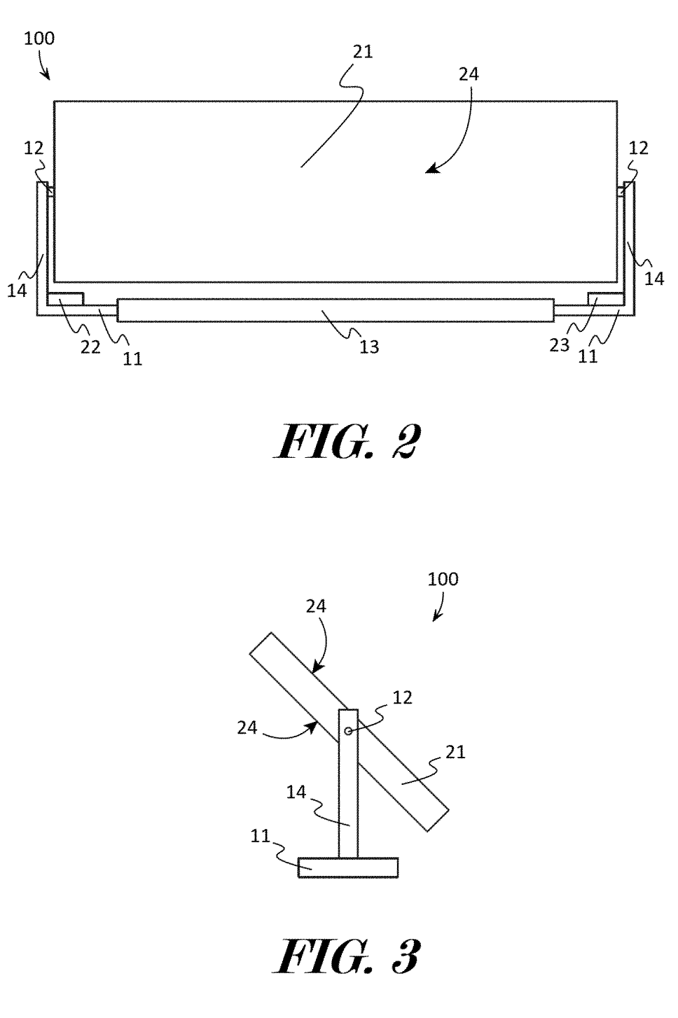

FIG. 2 illustrates a front elevation view of another example of an interactive advertising device 100 according to various embodiments described herein. In some embodiments, the device 100 may comprise a base 11 and a display 21. The display 21 may be coupled to the base 11 with one or more movable couplings 12 which may be positioned on opposing ends of the display 21. One or more mounts 13 may be configured to couple the base 11 to an object or surface. The display 21 may be configured to display information, such as indicia and graphics, to observers or users 201 of the device 100. The display 21 may be moved relative to the base 11 to facilitate the ability of observing users 201 to view the display 21 and any information displayed thereon. A traffic light sensor 22 may be in electronic communication with the display 21 and the traffic light sensor 22 may determine the status of a traffic light 207 and the device 100 may turn on, turn off, and/or alter the information displayed on the display 21 in response to the status of the traffic light 207. A radio module 53 may enable the device 100 to send and receive data in a wireless manner such as from a client device 400 of an observer or user 201, a server 300, and/or from a wireless network 205.

A perhaps best shown by FIG. 3, which illustrates a side elevation view of a further example of an interactive advertising device 100 according to various embodiments, the display 21 may be movable relative to the base 11 to facilitate the ability of observers or users 201 to view the display 21 and any information displayed thereon. Preferably, the display 21 may be pivoted relative to the base 11 with the one or more movable couplings 12 functioning as the pivot axis. In this manner, the display 21 may be pivoted to provide the optimum viewing angle for one or more observers or users 201. Optionally, the display 21 may comprise one or more display areas 24.

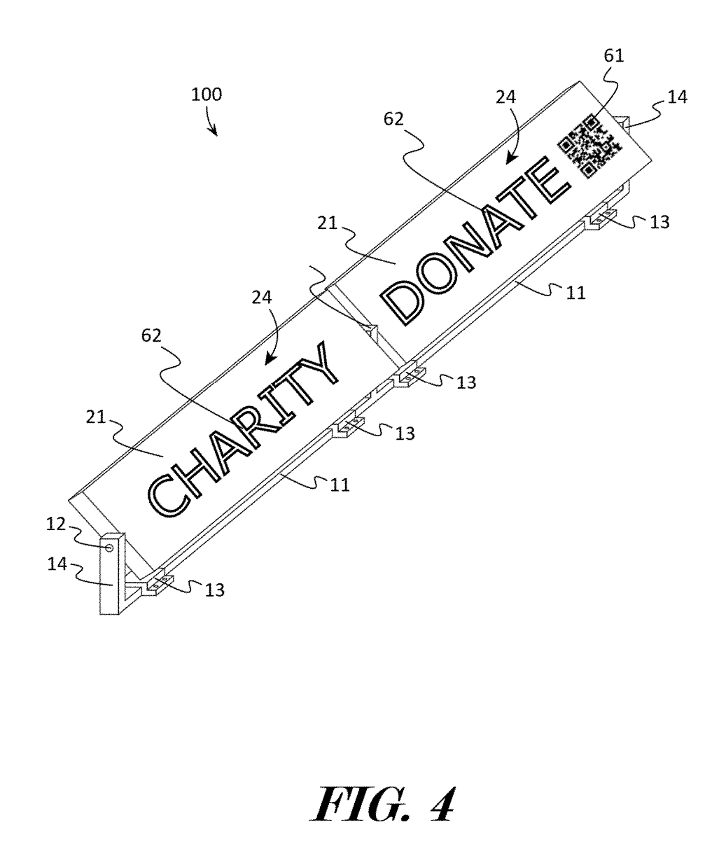

FIG. 4 depicts a perspective view of another further example of an interactive advertising device 100 according to various embodiments described herein. In some embodiments, the device 100 may comprise two or more displays 21 which may preferably be movable independently from each other, and which may preferably be configured to display complementary or different information to an observer or user 201. In the example of FIG. 4 and in other embodiments, two or more devices 100 may be mounted together, optionally by coupling the bases 11, movable couplings 12, and/or mounts 13 proximate or in contact with each other. One skilled in the art will recognize that the device 100 may be mounted or attached to vertical surfaces and objects, horizontal surfaces and objects, or surfaces and objects having any other orientation, thereby allowing the device 100 to occupy vertical orientations, horizontal orientations, or any other orientation.

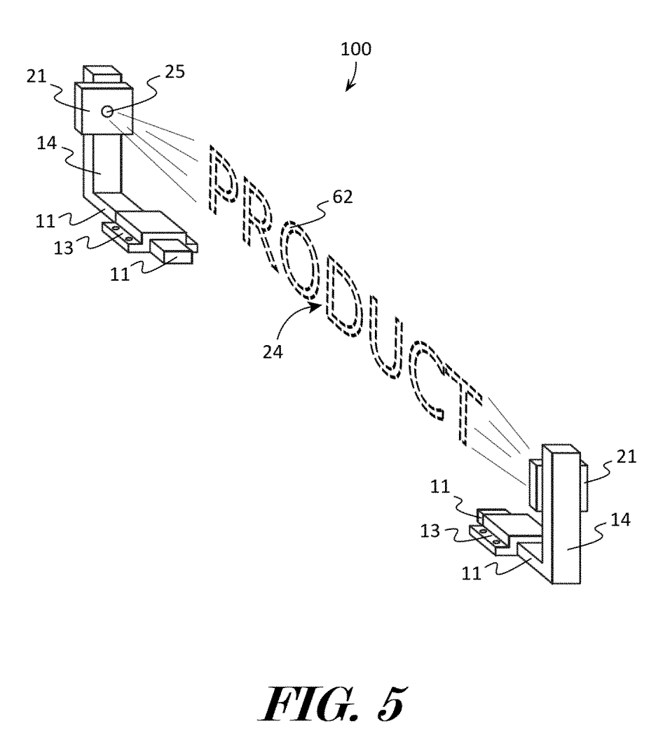

FIG. 5 depicts a perspective view of still another example of an interactive advertising device 100 according to various embodiments described herein. In some embodiments, the device 100 may comprise one or more bases 11 and one or more displays 21. Each display 21 may be coupled to a base 11 preferably with two or more displays 21 oriented towards or facing each other. One or more mounts 13 may be configured to couple a base 11 to an object or surface. In this example, the displays 21 may be configured as holographic displays or projection displays having one or more projectors 25 thereby enabling the displays 21 to display information, such as indicia and graphics, via projected light to observers or users 201 of the device 100.

Referring now to FIGS. 1-6, elements that the device 100 may comprise will be described. In some embodiments, the device 100 may comprise one or more bases 11 which may be used to hold and position elements of the device 100 such as a display 21. A base 11 may be configured in any shape and size. Preferably, a base 11 may comprise an extension 14 which may be used to position a display 21 a desired distance from an object or surface to which the device 100 may be coupled. In some embodiments, the device 100 may include one or more mounts 13 which may be configured to couple a base 11 to an object or surface to which the device 100 may be coupled, while in other embodiments, a base 11 may be coupled directly to an object or surface to which the device 100 may be coupled. A base 11 and a mount 13 may be configured to receive one or more fasteners, such as bolts, anchors, rivets, and adhesives, or any other type of fastener, which may be used to couple a base 11 and a mount 13 together and/or which may be used to couple a base 11 or mount 13 to an object or surface to which the device 100 may be coupled. A base 11 and/or mount 13 may be formed with any suitable rigid material, such as metal alloy cylindrical tubing, metal alloy square tubing, concrete, plastics, fiber glass, or any other suitable structural material. In preferred embodiments, a device 100 may be mounted to a road surface, media, traffic divider, or other object or surface preferably in proximity to a traffic light 207, while in other embodiments, a device 100 may be mounted anywhere such as shopping center sidewalks, shopping malls, sports fields and venues, and motor sport venues.

In some embodiments, the device 100 may comprise one or more movable couplings 12 which may be configured to couple a display 21 to a base 11 while allowing the display 21 to be moved relative to the base 11. In alternative embodiments, a display 21 may be coupled directly to a base 11 and not movable relative to the base 11. Preferably, a movable coupling 12 may be positioned on one or more sides, such as opposite sides, of a display 21 to couple the display to a base 11 and to allow the display 21 to be moved in one or more directions. A movable coupling 21 may include a rivet, bearing, nut and bolt, knuckle joint, a turnbuckle, a pin joint, a pivot joint, a cotter joint, a bolted joint, a flexible material joint, a screw joint, a universal joint, a butt hinge, butterfly hinge, flush hinge, barrel hinge, concealed hinge, continuous hinge, T-hinge, strap hinge, double-acting hinge, Soss hinge, a flexible material hinge, a four-bar linkage, a scissor linkage, a collapsible pole linkage, or any other suitable mechanical or physical linkage which may be used to couple a first element or component to a second element or component while allowing the first element or component to move, pivot, or rotate relative to the second element or component.

The device 100 may comprise one or more displays 21 having a display area 24 or surface which may be configured to visually display data and information, such as indicia and graphics, to observers or users 201 of the device 100. The display 21 may be moved relative to the base 11 to facilitate the ability of observers or users 201 to view the display 21 and for any other purpose. For example, the display 21 may be pivoted to allow for maintenance personnel to repair, access, or change the display 21 without requiring the device 100 or display 21 to have to be removed. In preferred embodiments, a display 21 and/or display area 24 may be configured to expand in both height and width such as to accommodate advertiser specifications and height or size restrictions. Additionally, the display 21 and/or display area 24 may display information as small as one inch by one inch to 3000 feet by 3000 feet, although the display 21 and/or display area 24 is not limited by these sizes. Optionally, the device 100 may comprise a sun screen or sun shade which may shield portions of the device 100 such as a display 21 and/or display area 24 from the sun.

In some embodiments, a display 21 and/or display area 24 may be configured with a generally rectangular shape as best shown in FIGS. 1, 2, and 4. However, it should be understood to one of ordinary skill in the art that a display 21, display area 24, and/or any other element discussed herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

In some embodiments, a display area 24 may be digital and may comprise or be formed by one or more light emitting devices such as a light-emitting diode (LED). Preferably, a display 21 may comprise a plurality LEDs so that the display area 24 may be configured as an LED display area. In still further embodiments, a display area 24 of a display 21 may comprise or be formed by a Liquid crystal display (LCD), Electroluminescent display (ELD), Electronic paper, E Ink, Plasma display panel (PDP), Cathode ray tube display (CRT), High-Performance Addressing display (HPA), Thin-film transistor display (TFT), Organic light-emitting diode display (OLED), Surface-conduction electron-emitter display (SED), Laser TV, Carbon nanotubes, Quantum dot display, Interferometric modulator display (IMOD), and/or any other device or method which may be configured to provide visual information.

In alternative embodiments, a display area 24 may comprise a durable surface upon which information in a durable form may be displayed. For example, vinyl signage, paper signage, laminated signage, or any other durable type or form of information, such as indicia and graphics, may be applied to a display area 24. In further embodiments, a display area 24 may comprise a transparent window behind which a durable type or form of information, such as indicia and graphics, may be scrolled behind. In still further embodiments, a display area 24 may comprise a plurality of movable slats which a durable type or form of information, such as indicia and graphics, may be applied to so that different information may be displayed by rotating the slats in unison.

In further alternative embodiments, the device 100 may comprise one or more projectors 25 which may be configured to create information, such as indicia and graphics, to observers or users 201 of the device 100 preferably on a digital display area 24. For example, a display area 24 may be a screen, building, cloud, or other surface or structure upon which one or more laser projectors which may be configured to project information onto. A projector 25 may comprise any type of video projector such as laser diode projectors, cathode ray tube (CRT) projectors, liquid crystal display (LCD) projectors, digital light processing (DLP) projectors, liquid crystal on silicon projectors (LCoS), light emitting diode (LED) projectors, hybrid LED and laser diode system projectors, or any other image projector that receives a video signal and projects the corresponding image using a lens system.

In further alternative embodiments and as perhaps best shown by FIG. 5, a display 21 may comprise one or more projectors 25 configured to provide a holographic display which may be a type of display that utilizes light diffraction to create a virtual three-dimensional image of an object. Preferably, a display 21 having a digital display area 24 configured as a holographic display may be unique from other forms of 3D imaging in that it may not require the aid of any special glasses or external equipment for a viewer to see the image.

In some embodiments, the device 100 may be configured to generate one or more matrix barcodes 61 on the display area 24 of the device 100. A matrix barcode 61 may comprise any optical, machine-readable, representation of data which may be optically recorded by a client device 400, such as via an input/output (I/O) interface 404 configured as a camera. A matrix code 61, sometimes called a 2D barcode or simply a 2D code, is a two-dimensional way to represent information preferably which may be readable by client devices 400. It is similar to a linear (1-dimensional) barcode, but can represent more data per unit area. Exemplary matrix barcodes 61 include Aztec Code, CrontoSign, Data Matrix, DotCode, EZcode, High Capacity Color Barcode, Han Xin Barcode, MaxiCode, NexCode, Qode, QR code, AR Code, ShotCode, and SPARQCode although any other type of 2D barcode may be used. In alternative embodiments, the device 100 may comprise one or more matrix barcodes 61 positioned anywhere on the device 100.

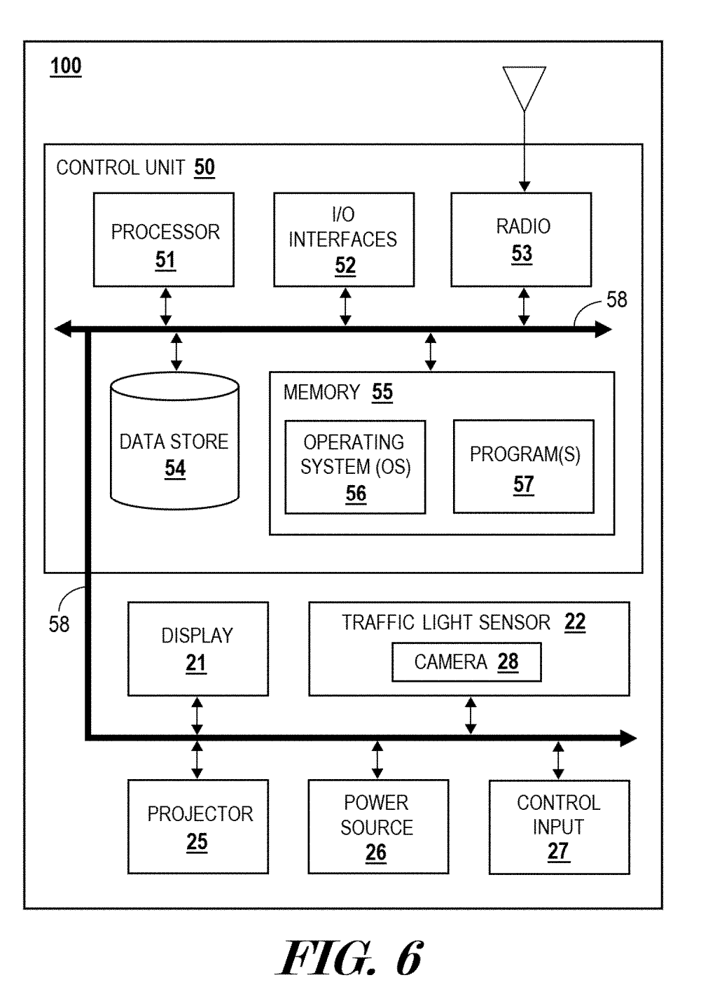

In some embodiments and in the present example, the device 100 can be a digital device that, in terms of hardware architecture, comprises a control unit 50 which optionally includes a processor 51, input/output (I/O) interfaces 52, a radio module 53, a data store 54, and memory 55. It should be appreciated by those of ordinary skill in the art that FIG. 6 depicts the device 100 in an oversimplified manner, and a practical embodiment may include additional components or elements and suitably configured processing logic to support known or conventional operating features that are not described in detail herein. The components and elements (50, 51, 52, 53, 54, 55, 21, 22, 25, 26, 27, and 28,) are communicatively coupled via a local interface 58. The local interface 58 can be, for example but not limited to, one or more buses, circuit boards, wiring harnesses, or other wired connections or wireless connections, as is known in the art. The local interface 58 can have additional elements, which are omitted for simplicity, such as controllers, buffers (caches), drivers, repeaters, and receivers, among many others, to enable communications. Further, the local interface 58 may include address, control, and/or data connections to enable appropriate communications among the aforementioned components.

The processor 51 is a hardware device for executing software instructions. The processor 51 can be any custom made or commercially available processor, a central processing unit (CPU), an auxiliary processor among several processors associated with the control unit 50, a semiconductor-based microprocessor (in the form of a microchip or chip set), or generally any device for executing software instructions. When the processing unit 50 is in operation, the processor 51 is configured to execute software stored within the memory 55, to communicate data to and from the memory 55, and to generally control operations of the device 100 pursuant to the software instructions and/or from instructions received from a remote control 70, translator 80, or a client device 400. In an exemplary embodiment, the processor 51 may include a mobile optimized processor such as optimized for power consumption and mobile applications.

The I/O interfaces 52 can be used to by a user 201 to provide input, such as which may be used to control the speed and direction of the wheel 13, to the device 100 or to receive information, such as power levels or operational status, from the device 100. The I/O interfaces 52 can also include, for example, buttons, knobs, switches, LED indicator lights, LED display, LCD display, a serial port, a parallel port, a small computer system interface (SCSI), an infrared (IR) interface, a radio frequency (RF) interface, a universal serial bus (USB) interface, and the like.

A radio module 53 may enable the device 100 to send and receive data in a wireless manner such as from a client device 400 of an observer or user 201 and/or from a wireless network 205. Preferably, the device 100 may include a radio module 53 and the device 100 may provide advertising information, charity donation information, traffic advisory alert information, missing person's information, blood donation information, or any other information on the display 21 which may also be augmented via information provided by an optional radio module 53. In further embodiments, the radio module 53 may be configured to communicate with client devices 400 proximate to the device 100, such as within 1000 feet, and preferably within 20 feet, of the device 100, such as by broadcasting to client devices 400 configured to wirelessly communicate via their respective radios 406.

In preferred embodiments, a radio module 53 may comprise a Bluetooth and/or WiFi receiver and transmitter which enables wireless communication to a network or an external access client device such as cell phones, smart phones, tablet computers, laptop computers, wearable computers such as watches, Google Glasses, etc. and the like. In other embodiments, a radio module 53 may comprise a receiver and transmitter which enables any number of suitable wireless data communication protocols, techniques, or methodologies including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Near-Field Communication (NFC); Frequency Hopping Spread Spectrum; Long Term Evolution (LTE); cellular/wireless/cordless telecommunication protocols (e.g. 3G/4G, etc.); iBeacon; wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. In further embodiments, a radio module 53 may comprise a wired network connection.

An optional data store 54 may be used to store data. The data store 54 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 54 may incorporate electronic, magnetic, optical, and/or other types of storage media.

The memory 55 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 55 may incorporate electronic, magnetic, optical, and/or other types of storage media. Note that the memory 55 may have a distributed architecture, where various components are situated remotely from one another, but can be accessed by the processor 51. The software in memory 55 can include one or more software programs, each of which includes an ordered listing of executable instructions for implementing logical functions. In the example of FIG. 6, the software in the memory system 55 includes a suitable operating system (O/S) 56 and program(s) 57. The operating system 56 essentially controls the execution of input/output interface 52 functions, and provides scheduling, input-output control, file and data management, memory management, and communication control and related services. The operating system 56 may be, for example, LINUX (or another UNIX variant), Android (available from Google), Symbian OS, Microsoft Windows CE, Microsoft Windows 7 Mobile, iOS (available from Apple, Inc.), webOS (available from Hewlett Packard), Blackberry OS (Available from Research in Motion), and the like. The programs 57 may include various applications, add-ons, etc. configured to provide end user functionality with the device 100. For example, exemplary programs 57 may include, but not limited to, instructions for operating the display 21 to cause information to be visually displayed on a display area 24. In a typical example, one or more of the programs 57 may control: the period of time the display area 24 visually displays data; which data is visually displayed on the display area 24 in response to the status of a traffic light 207 that a traffic light sensor 22 is monitoring; which data is sent to or received from a client device 400; which data is sent to or received from a server 300; which matrix barcode 61 is visually displayed on the display area 24; and/or any other function of the device 100.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The control unit 50 may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by the processor 51. In addition, the main memory may be used for storing temporary variables or other intermediate information during the execution of instructions by the processor 51. The control unit 50 may further include a read only memory (ROM) or other static storage device (e.g., programmable ROM (PROM), erasable PROM (EPROM), and electrically erasable PROM (EEPROM)) coupled to the bus for storing static information and instructions for the processor 51.

In some embodiments, the device 100 may comprise one or more traffic light sensors 22 which may be in electronic communication with the display 21. A traffic light sensor 22 may determine the status of a traffic light 207 near or proximate, such as within 500 feet, to the device 100, and the device 100 may turn on, turn off, and/or alter or vary the information displayed on the display area 24 or by the display 21 in response to the status of the traffic light 207. A traffic light sensor 22 may be any type of sensor or device configured to determine the status of a traffic light 207 near or proximate to the device 100. In preferred embodiments, a traffic light sensor 22 may comprise a camera 28 or other imaging device configured to visually identify if a traffic light near or proximate to the device 100 is green, yellow, or red, and the device 100 may turn on the display area 24 or the display 21 when the light is red, turn off the display area 24 or the display 21 when the light is green and yellow, and/or otherwise alter the information displayed on the display area 24 or by the display 21 in response to the status of the traffic light 207.

A camera 28 may be configured to record still images or video images of one or more traffic lights 207 in the environment around the device 100 and preferably of a traffic light 207 generally located proximate to the device 100. In preferred embodiments, a camera 28 may comprise a digital camera that encodes images and videos digitally on a charge-coupled device (CCD) image sensor or on a complementary metal-oxide-semiconductor (CMOS) image sensor and stores them for later reproduction. In other embodiments, a camera 28 may comprise any type of camera which includes an optical system, typically using a lens with a variable diaphragm to focus light onto an image pickup device or image sensor.

In some embodiments, the device 100 may comprise a power source 26 which may provide electrical power to any component that may require electrical power. A power source 26 may comprise a battery, such as a lithium ion battery, nickel cadmium battery, alkaline battery, or any other suitable type of battery, a fuel cell, a capacitor, a super capacitor, or any other type of energy storing and/or electricity releasing device. In further embodiments, a power source 26 may comprise a power cord, kinetic or piezo electric battery charging device, a solar cell or photovoltaic cell, and/or inductive charging or wireless power receiver. In further embodiments, a power source 26 may comprise a power charging and distribution module which may be configured to control the recharging of the power source 26, discharging of the power source 26, and/or distribution of power to one or more components of the device that may require electrical power.

In some embodiments, the device 100 may comprise one or more user control inputs 27 that a user 201 may interact with such as turnable control knobs, depressible button type switches, a key pad, slide type switches, rocker type switches, or any other suitable input that may be used to enable the user 201 to control functions and/or elements of the device 100.

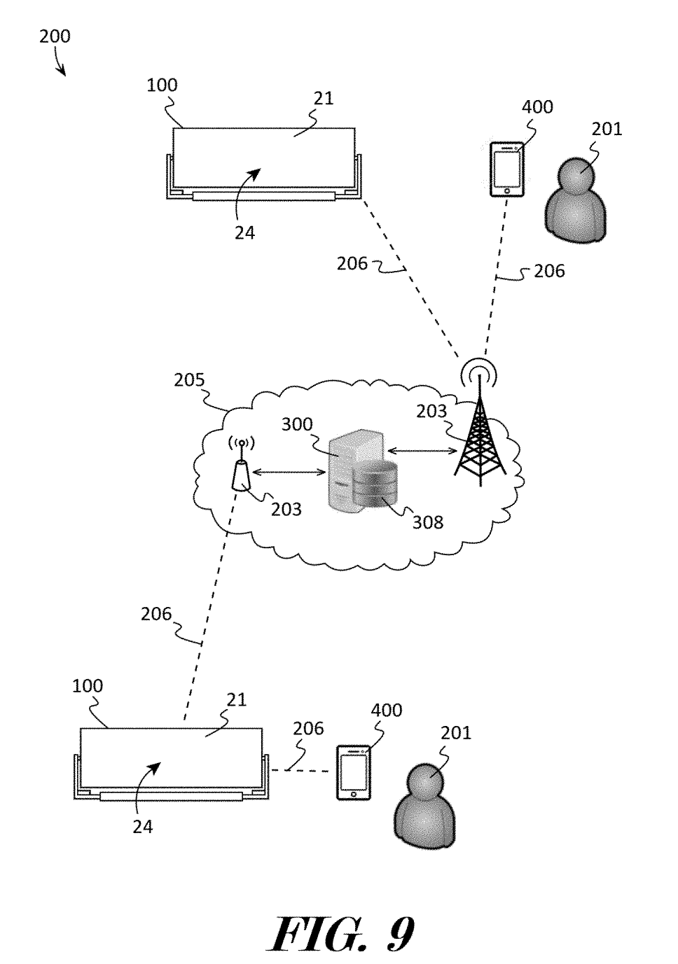

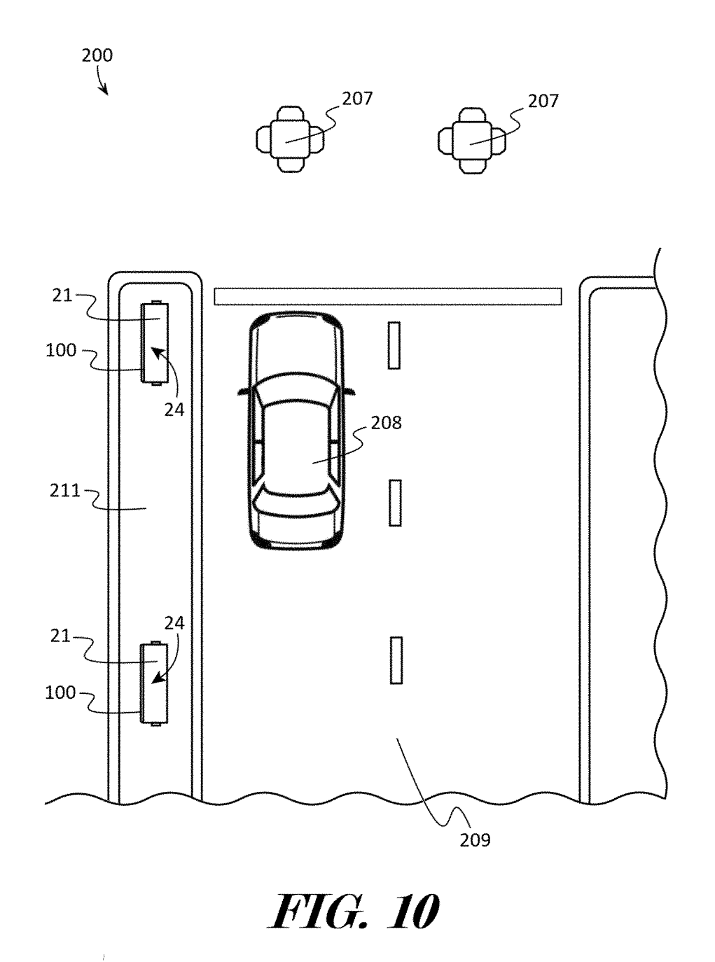

FIGS. 9 and 10 shows examples of interactive advertising systems 200 comprising interactive advertising devices 100 in electronic communication with client devices 400 which may be positioned proximate to one or more traffic lights 207 according to various embodiments described herein. In some embodiments, an interactive advertising system (“the system”) 200 may comprise one or more interactive advertising devices 100. Optionally, an interactive advertising device 100 may be in communication 206 with one or more other interactive advertising devices 100 of a system 100. In further embodiments, the system 200 may comprise one or more client devices 400 which may be in communication 206 with one or more interactive advertising devices 100, such as via a respective radio module 53, proximate to the client devices 400. In still further embodiments, the system 200 may comprise one or more servers 300 which may be in communication 206 with one or more interactive advertising devices 100 and/or which may be in communication 206 with one or more client devices 400 proximate to an interactive advertising device 100.

A device 100 may be positioned anywhere, such as proximate to a location where users 201 in a vehicle 208, on a bicycle, and/or walking may view the display area 24 of the device 100. In preferred embodiments, a device 100 may be positioned proximate to a traffic light 207, such as on a median 211 or other traffic guiding method, commonly found on a road 209. In further embodiments, the system 200 may comprise a traffic light 207. Traffic lights 207, also known as traffic signals, traffic lamps, traffic semaphore, signal lights, stop lights, robots (in South Africa), and traffic control signals (in technical parlance), are signaling devices positioned at road 209 intersections, pedestrian crossings, and other locations to control flows of vehicle 208 traffic. Traffic lights 207 alternate the right of way accorded to users by displaying lights of a standard color (red, amber (yellow), and green) following a universal color code. In this manner, a traffic light 207 may have a particular status indicated by the colored light it is displaying or by the location of the light that is illuminated on the traffic light 207. For example, a traffic light 207 may display a green light indicating that the traffic light 207 is in a first status, a yellow light indicating that the traffic light 207 is in a second status, and a red light indicating that the traffic light 207 is in a third status. Generally, a traffic light 207 in a first status (green light) may indicate for traffic to proceed past the traffic light 207, a traffic light 207 in a second status (yellow light) may indicate that the traffic light 207 is about to change to a third status and for traffic to proceed past the traffic light 207, and a traffic light 207 in a third status (red light) may indicate for traffic to stop at the traffic light 207. In preferred embodiments, the device 100 may comprise a traffic light sensor 22 which may be configured to determine a status of a traffic light 207 proximate to the device 100 by recording the color of light displayed and/or the location of the light on the traffic light 207. Additionally, a traffic light sensor 22 which may be configured to determine the change in a status of a traffic light 207 by determining a change in the color of light or location of light displayed by the traffic light 207.

The processing unit 50 may control the display 21 to produce visually displayed data 62 on the display area 24 and to change the data which is visually displayed on the display area 24. In some embodiments, the processing unit 50 may control the display area 24 to change the visually displayed data 62 in response to a change in the status of a traffic light 207 proximate to the device 100. For example, when the traffic light sensor 22 determines that the traffic light 207 has changed its status from a third or red status to a first or green status, the processing unit 50 may change the visually displayed data 62 on the display area 24. In some embodiments, the processing unit 50 may control the display area 24 to visually display data 62 when a traffic light 207 proximate to the device 100 is in or indicating a desired status. For example, when the traffic light sensor 22 determines that the traffic light 207 is in a third or red status, the processing unit 50 may control the display area 24 to visually display data 62 on the display area 24. In further embodiments, the processing unit 50 may control the display area 24 to stop visually displaying data 62 when a traffic light 207 proximate to the device 100 is in or indicating a particular status. For example, when the traffic light sensor 22 determines that the traffic light 207 is in a first or green status and/or a second or yellow status, the processing unit 50 may control the display area 24 to turn of the display area 24 thereby ceasing the visual display of data 62 on the display area 24. In still further embodiments, processing unit 50 may control the display 21 so that the display area 24 stops displaying data 62 when the traffic light sensor 22 determines that the status of the traffic light 207 is not indicating for traffic to stop at the traffic light, such as when the traffic light 207 is in a first or green status and a second or yellow status.

In some embodiments, the device 100 may be configured to wirelessly communicate with the client device 400 of a user 201 when the use's 201 client device 400 is proximate to the device 100, such as when the user 201 is in a vehicle 208 and the vehicle is proximate to the device 100. In further embodiments, the processing unit 50 may control the display area 24 to change the visually displayed data 62 on the display area 24 in response to data received from a client device 400 proximate to the device 100.

In some embodiments, the system 200 may comprise a device 100 and a server 300. The device 100 may be in wired or wireless communication 206 with a server 300 and preferably in communication 206 with a server 300 that enables the device 100 to have internet access. Preferably, the device 100 may receive data, such as advertising information, charity donation information, traffic advisory alert information, missing person information, blood donation information, or any other information, which may be visually displayed on a display area 24 from a server 300 or optionally from a client device 400. In further embodiments, the device 100 may be in communication 206 with a wired or wireless network 205. For example, the radio module 53 may be in communication 206 with a server 300 on a wireless network 205. The device 100 may receive data which may be used to form the visually displayed data 62 on the display area 24 from a server 300. Optionally, the device 100 may enable the exchange of data between a client device 400 and server 300, such as by the device 100 acting as an internet gateway. In further embodiments, the device 100 may provide data describing one or more client devices 400 that the device 100 has communicated with to a server 300.

In some embodiments, a radio module 53 may enable the device 100 to accept wireless mobile charity donations from one or more individuals, such as via their smart phone or other client device 400. Optionally, the device 100 may provide digital coupons and discounts to the client device 400 of the individuals or users 201 in response to donations and contributions from the client devices 400 of the users 201. For example, the display 21 and/or display area 24 may provide information which includes a matrix barcode 61, such as QR code, which may be read by a camera of client devices 400 and used to establish wireless communication 206 with one or more client devices 400. In further embodiments, the radio module 53 may enable an application running on a client device 400 to be set to automatically retrieve and display information on the client device 400 and/or via the display 21 when the client device 400 is in close proximity to the device 100 such as when a user 201 of the client device 100 is driving or walking by the device 100.

While some materials have been provided, in other embodiments, the elements that comprise the device 100 such as the base 11, display 21, optional mounts 13, optional extension 14, and/or any other element discussed herein may be made from durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. An interactive advertising device, the device comprising:
a base;
a display having a digital display area, the display area configured to visually display data;
a movable coupling configured to movably couple the display to the base; and
a traffic light sensor configured to determine a status of a traffic light proximate to the device, wherein the display area changes the visually displayed data in response to a change in the status of the traffic light.

2. The device of claim 1, further comprising a radio module.

3. The device of claim 2, wherein the radio module is configured to communicate with a client device proximate to the device.

4. The device of claim 3, wherein the display area changes the visually displayed data in response to data received from the client device.

5. The device of claim 2, wherein the radio module is in communication with a server.

6. The device of claim 1, wherein the visually displayed data comprises a matrix barcode.

7. The device of claim 1, wherein the display area comprises a plurality of light emitting diodes.

8. The device of claim 1, wherein the display area comprises a liquid crystal display.

9. The device of claim 1, wherein the display comprises a projector.

10. The device of claim 1, wherein the traffic sensor comprises a camera.

11. The device of claim 1, wherein the display area stops displaying data when the traffic light sensor determines that the status of the traffic light is not indicating for traffic to stop at the traffic light.

12. An interactive advertising system, the system comprising a client device and an interactive advertising device, the interactive advertising device having:
a base;
a display having a digital display area, the display area configured to visually display data;
a movable coupling configured to movably couple the display to the base;
a radio module, the radio module configured to communicate with the client device; and
a traffic light sensor configured to determine a status of a traffic light proximate to the device, wherein the display area changes the visually displayed data in response to a change in the status of the traffic light.

13. The system of claim 12, wherein the display area changes the visually displayed data in response to data received from the client device.

14. The system of claim 12, further comprising a server, wherein the radio module is in communication with the server.

15. The system of claim 12, wherein the visually displayed data comprises a matrix barcode.

16. The system of claim 12, wherein the display area comprises a plurality of light emitting diodes.

17. The system of claim 12, wherein the display area comprises a liquid crystal display.

18. The system of claim 12, wherein the display comprises a projector.

19. The system of claim 12, wherein the traffic sensor comprises a camera.

20. The system of claim 12, wherein the display area stops displaying data when the traffic light sensor determines that the status of the traffic light is not indicating for traffic to stop at the traffic light.
